(19) United States
(12) Patent Application Publication
(10) Pub. No.: US 2024/0068903 A1
(43) Pub. Date: Feb. 29, 2024

(54) GENERATION OF CFD-BASED STRUCTURALLY INDEPENDENT AERODYNAMIC INFLUENCE COEFFICIENT MATRIX

(71) Applicant: Pin-Chih Chen, Scottsdale, AZ (US)

(72) Inventor: Pin-Chih Chen, Scottsdale, AZ (US)

(21) Appl. No.: 17/890,805

(22) Filed: Aug. 18, 2022

(51) Int. Cl. G01M 9/08; G06F 30/15; G06F 30/28

(52) U.S. Cl. CPC G01M 9/08; G06F 30/15; G06F 30/28

(57) ABSTRACT

This invention is a methodology, called CFD-based AIC generator, that can generate CFD-based structurally-independent Aerodynamic Influence Coefficient (AIC) matrices. Because the AIC matrices are independent of structure, they can be repeatedly used during the flight vehicle's structural design cycle for a fixed aerodynamic configuration to rapidly generate flutter, aeroservoelastic (ASE), and dynamic loads solutions. Inputs to processing include a CFD surface mesh, a coarsening ratio criterion, and a mid-layer panel model. The coarsening ratio criterion is computed from the CFD mesh. The mid-layer panel model is comprised of coarsened grid points derived from the CFD mesh and the coarsening ratio criterion.

### STATEMENT OF GOVERNMENT INVOLVEMENT

This application involves an invention made with United States Government support under a Small Business Innovative Research (SBIR) Program, Phase I entitled, “Generation of CFD-Based Structurally Independent Aerodynamic Influence Coefficient Matrix,” having Contract Number: 80NSSC200369 awarded by NASA Langley Research Center (National Aeronautics and Space Administration's Langley Research Center, Hampton, VA 23666).

### FIELD OF THE INVENTION

The present invention relates generally to a methodology that can drive a computational fluid dynamics (CFD) solver to generate the structurally independent aerodynamic influence coefficient (AIC) matrices for aeroelastic analysis. During a flight vehicle's structural design cycle of a fixed aerodynamic configuration, the AIC matrices can be repeatedly used to rapidly generate aeroelastic solutions of the redesigned a flight vehicle's structures without any additional CFD computation.

### BACKGROUND OF THE INVENTION

Despite advances of Computational Fluid Dynamics (CFD) methods, applications of CFD to an aeroelastic analysis using the time-marching approach is still not well-accepted by the aerospace industry. One obvious reason is the high cost of the CFD computation because whenever the structural design is changed, the CFD computation must be executed again. Also, the time-marching CFD approach can only determine the first flutter mode because it cannot proceed further beyond the lowest flutter speed due to the divergent oscillatory response. Usually, the flutter engineer in the aerospace industry would like to find all critical flutter modes occurring in the flight envelope so that they can modify the structural design to resolve these flutter problems. This is the reason that the aerospace industry prefers to solve the aeroelastic equation in the frequency domain that reads:

[−ω²[Mₕₕ]+iω[Cₕₕ]+[Kₕₕ]−q_{∞}[Qₕₕ(ik)]]{ξ}=q_{∞}[Q_{hc}(ik)]{δ}+q_{∞}[Q_{hg}(ik)]w_{g} (1)

where [Mₕₕ], [Cₕₕ], and [Kₕₕ] are the generalized mass, damping, and stiffness matrices, respectively, that can be provided by the commercially available structural finite element solvers, (the subscript h denotes the number of modes), q_{∞} is the dynamic pressure, {ξ} is the generalized coordinates vector, {δ} is the control surface deflection vector, and w_{g} is the gust velocity profile such as the one-minus-cosine profile. Usually, the most time-consuming parts of establishing Equation (1) are the generation of the Generalized Aerodynamic Forces (GAF) due to h number of structural modes [Qₕₕ(ik)], c number of control surface kinematic modes [Q_{hc}(ik)], and due to gust [Q_{hg}(ik)], where k=ωL/V is the reduced frequency, L is the reference length, and V is the freestream velocity. These generalized aerodynamic forces are provided by the unsteady aerodynamic computation that solves the linear potential equation or the high-fidelity Euler/Navier-Stokes equations. Currently, the unsteady panel methods such as Doublet Lattice Method [Rodden, W. P., Giesing, J. P. and Kalman, T. P., “New Development and Applications of the Subsonic Doublet-Lattice Method for Nonplanar Configurations,” AGARD Conf. Proc. No. 80-71, Part II, No. 4, 1971] and ZONA6 [Chen, P. C., Lee, H. W. and Liu, D. D., “Unsteady Subsonic Aerodynamics for Bodies and Wings with External Stores Including Wake Effect,” Journal of Aircraft, Vol. 30, No. 5, September-October 1993, pp. 618-628.] for solving the subsonic potential equation, and ZONA7 [Chen, P. C. and Liu, D. D., “Unsteady Supersonic Computations of Arbitrary Wing-Body Configurations Including External Stores,” Journal of Aircraft, Vol. 27, No. 2, February 1990, pp. 108-116.] for solving the supersonic potential equation are still the primary methods used by the aerospace industry because these panel methods can generate the Aerodynamic Influence Coefficient (AIC) matrix in the frequency domain. The AIC matrix is a complex matrix with a size equal to the number of panels in the aerodynamic model. The j^{th} row of the i^{th} column in the AIC matrix contains the unsteady pressure coefficient on the j^{th} panel due to a unit input at the control point of the i^{th} panel. Thus, the AIC matrix contains the purely unsteady aerodynamic characteristics of the aerodynamic geometry and, therefore, is independent of the structure. Once the AIC matrix is available, the [Qₕₕ(ik)]ϵ [symbol] ^{h×h} and [Q_{hc}(ik)]ϵ [symbol] ^{h×c} matrices can be rapidly computed using the following equations:

[Qₕₕ(ik)]=[ϕₕ]^{T}[S][AIC(ik)][ϕₕ]

[Q_{hc}(ik)]=[ϕₕ]^{T}[S][AIC(ik)][ϕ_{c}] (2)

where [S] is an integration matrix to convert pressures to forces, [ϕₕ] is the structural mode shapes, and [ϕ_{c}] is the control surface kinematic modes. The AIC matrix can also be used to generate the Q_{hg}(ik) matrix by the following equation:

[Q_{hg}(ik)]=[ϕₕ]^{T}[S][AIC(ik)]{e^{-ω(x-x}^{₀}^{)/V}} (3)

where x is the control point locations of the panel model and x₀ is the gust reference point.

Because the AIC matrix is independent of the structure, once the aerodynamic configuration is fixed during the flight vehicle's structural design process, the AIC matrix can be repeatedly used for structural design. Also, the AIC matrix is an ideal aerodynamic force generator for structural sizing optimization involving aeroelastic constraints because it only needs to be computed once prior to the optimization iterations. Furthermore, because the increase of computational time for generating GAF from the AIC matrix due to the increase of the number of structural modes is small, the AIC matrix can be used to determine the required number of structural modes for accurate aeroelastic analysis, i.e. a convergence study is usually required for a modal-based aeroelastic analysis.

However, because of the linear potential flow assumption, the unsteady panel methods are not valid at transonic and hypersonic Mach numbers nor at high angles-of-attack. In these flow conditions, accurate unsteady aerodynamic forces only can be obtained by solving the Euler or Navier-Stokes (N-S) equations. Therefore, the aerospace industry would greatly benefit from having an innovative method that can efficiently generate the AIC matrix from a CFD method.

### SUMMARY OF THE INVENTION

The objective of this invention is to provide a CFD-based AIC generator for generating the structurally independent AIC matrices using a high fidelity CFD solver. The high fidelity CFD solver can be either a public-domain code such as FUN3D developed by NASA Langley Research Center and SU² by Stanford University or a commercial CFD solver such as Fluent and CFX developed by ANSYS, CFD++ by Metacomp Technologies Inc., STAR-CCM+ by Siemens and Cobalt by Cobalt solution LLC. Using these AIC matrices, the Generalized Aerodynamic Forces (GAF) due to structural modes and control surface kinematic modes can be rapidly obtained using Equation (2). Also, the GAF due to gust excitation can be computed using Equation (3). With these three GAFs available, Equation (1) can be constructed to perform the frequency-domain flutter, aeroservoelastic (ASE), and dynamic loads analysis.

Because the output of the AIC matrix is the linearized unsteady pressure coefficients, it is required to linearize the CFD solver using two approaches. The first approach is the Finite Difference (FD) method that is applied to a CFD solver in which all floating numbers are programmed in the real variables. For a given mode shape vector, {ϕ}, with an amplitude of ξ_{ϵ} and a unit excitation signal of [symbol] (t) specified on the surface mesh defined by {X₀}, the moving surface mesh to define the total unsteady motion is {X₀}+ξ_{ϵ} [symbol] (t){ϕ}. Defining the unsteady CFD solver as a nonlinear real variable operator, ℑᵣ, where the subscript r denotes the real variable version of the CFD solver, the total unsteady aerodynamic pressure coefficients about the mean flow condition, {Cₚ_{_{T}}(t)}, computed by the CFD solver can be expressed by the following equation:

{Cₚ_{_{T}}(t)}=ℑᵣ({X₀}+ξ_{ϵ} [symbol] (t){ϕ}) (4)

Because each column of the AIC matrix is the linearized unsteady aerodynamic pressure distribution per a unit amplitude, {Cₚ(t)}, the mean aerodynamic pressures must be subtracted from the CFD computed total unsteady aerodynamic pressures then divided the resulting pressures by ξ_{ϵ} using the following equation:

$$\{ {C}_{p} ( t ) \} \approx \frac{{\tilde{𝒮}}_{r} ( \{ {X}_{0} \} + {ξ}_{ε} ζ ( t ) \{ ϕ \} ) - {\tilde{𝒮}}_{r} ( \{ {X}_{0} \} )}{{ξ}_{ε}} \qquad ( 5 )$$

Here, Equation (5) is defined as a Finite Difference (FD) method where ξ_{ϵ} must be sufficiently small but not too small to avert the numerical subtraction error. The FD method for computing {Cₚ(t)} requires an unsteady CFD computation to yield ℑᵣ({X₀}+ξ_{ϵ} [symbol] (t){ϕ}) and a steady CFD computation to yield ℑᵣ({X₀}). Also, the accuracy of {Cₚ(t)} depends on the choice of the value of ξ_{ϵ} whose best value must be determined by a trial-and-error procedure.

The second approach for generating the linearized unsteady pressure distribution is to apply the Complex Variable Differentiation (CVD) technique to a CFD solver that is programmed by the complex variables and is represented by a nonlinear complex variable operator ℑ_{c}, where the subscript c denotes the complex variable version of the CFD solver. By incorporating the surface mesh, {X₀}, in the real part and the unsteady motion, ξ_{ϵ} [symbol] (t){ϕ}, in the imaginary part of the complex unsteady boundary condition, the complex total unsteady aerodynamic pressure, {Cₚ_{_{c}}(t)} computed by the complex-variable CFD solver can be represented by:

{Cₚ_{_{c}}(t)}=ℑ_{c}({X₀}, iξ_{ϵ} [symbol] (t){ϕ}) (6)

Assuming ξ_{ϵ}<<1 (e.g., 10⁻⁵⁰) and using Taylor's expansion, {Cₚ(t)} can be directly obtained from the imaginary part of the complex aerodynamic pressures computed by the complex-variable CFD solver as:

{Cₚ(t)}=imag{Cₚ_{_{c}}(t)}/ξ_{ϵ} (7)

Because of ξ_{ϵ}=10⁻⁵⁰, the high order terms from Taylor's expansion are below machine zero in a 64-bit computer. Therefore, the unsteady aerodynamic pressures generated by the complex-variable CFD solver is the numerically exact linearized unsteady aerodynamic pressure distribution. This CVD technique expressed in Equations (6) and (7), when applied to a CFD viscous/inviscid computation, is referred to herein as the numerically Exact Linearized Viscous Unsteady Solver (ELVUS).

The derivation of Equation (7) from Equation (6) via Taylor's expansion is shown below:

$$\{ {C}_{{p}_{c}} ( t ) \} = {𝔍}_{c} ( \{ {X}_{0} \} , i {ξ}_{ε} ϛ ( t ) \{ ϕ \} ) \approx Re {𝔍}_{c} ( \{ {X}_{0} \} ) + i {ξ}_{ε} Re [ \frac{\partial {𝔍}_{c}}{\partial \{ {X}_{0} \}} ϛ ( t ) ] \{ ϕ \} = {𝔍}_{r} ( \{ {X}_{0} \} ) + i {ξ}_{ε} [ \frac{\partial {𝔍}_{r}}{\partial \{ {X}_{0} \}} ϛ ( t ) ] \{ ϕ \} \qquad ( 8 )$$

Carefully examining the term

$$[ \frac{\partial {𝔍}_{r}}{\partial \{ {X}_{0} \}} ϛ ( t ) ] ∈ {ℝ}^{{N}_{CFD} \times {N}_{CFD}} ,$$

where N_{CFD} is the number of the CFD surface grid points, in the right-hand side of Equation (8) and assuming [symbol] (t) to be a delta function, it can be realized that

$$[ \frac{\partial {𝔍}_{r}}{\partial \{ {X}_{0} \}} ϛ ( t ) ]$$

represents a Multi-Input-Multi-Output (MIMO) linearized unsteady aerodynamic transfer function matrix. In fact, it is equivalent to the AIC matrix generated by the linear unsteady aerodynamic panel method except in the time domain. Multiplying this AIC matrix to a mode shape vector yields the linearized unsteady pressure distribution shown below:

$$[ \frac{\partial {𝔍}_{r}}{\partial \{ {X}_{0} \}} ϛ ( t ) ] \{ ϕ \} = [ AIC ( t ) ] \{ ϕ \} = \{ {C}_{p} ( t ) \} \qquad ( 9 )$$

Thus, Equation (7) can be derived by plugging Equation (9) into Equation (8).

Since the objective of this invention is to generate the AIC matrix in the frequency domain, the excitation signal of [symbol] (t) is replaced by [symbol] (t)=sin(ωt). Then, applying Fourier transform (represented by the operator F_{T}) to the matrix

$$[ \frac{\partial {𝔍}_{r}}{\partial \{ {X}_{0} \}} ϛ ( t ) ]$$

in Equation (9) yields the AIC matrix in the frequency domain shown by the following equation:

$$[ AIC ( i ω ) ] = {F}_{T} [ \frac{\partial {𝔍ϛ}_{r}}{\partial \{ {X}_{0} \}} sin ( ω t ) ] \qquad ( 10 )$$

In the i^{th} column, the AIC matrix shown in Equation (10) contains the frequency-domain aerodynamic pressure coefficients at N_{CFD} number of CFD surface grid points due to an impulse input at the i^{th} surface grid. Thus, to generate the AIC matrix requires N_{CFD} number of CFD unsteady computations.

However, because the CFD mesh of a Three-Dimensional (3D) configuration can easily contain over thousands if not millions of surface grid points, generating the AIC matrix using the Point-by-Point Excitation (PPE) approach is computationally unaffordable. This technical issue can be resolved by a Master Point Excitation (MPE) approach that can drastically reduce the computational time for the AIC generation.

### BRIEF DESCRIPTION OF THE DRAWINGS

The present invention will hereinafter be described in conjunction with the following drawing figure, wherein like numerals denote like elements, and

FIG. 1 is a diagrammatic view illustrating components of the exemplary CFD-based AIC Generator and its input and output for generating the GAFs during the flight vehicle's, structural design cycles, in accordance with a preferred embodiment of the present invention;

FIG. 2 is a diagrammatic view illustrating an exemplary mapping of CFD grid points to an exemplary midlevel panel model (MLPM) panel, according to a preferred embodiment of the present invention;

FIG. 3 is a three-dimensional computer graphic view illustrating exemplary graphs of four bi-linear Lagrange shape functions according to a preferred embodiment of the present invention;

FIG. 4 is a three-dimensional computer graphic view illustrating an exemplary excitation amplitude at the i^{th} panel grid and its shape functions, according to a preferred embodiment of the present invention;

FIGS. 5A and 5B is a computer graphic view illustrating an exemplary Composite Sinusoidal Excitation for k=0.1, 0.25, 0.5, 0.75, 1.0. (a=0.05), according to a preferred embodiment of the present invention; and

FIG. 6 is a process flow view of an exemplary method of generation of CFD-based structurally independent aerodynamic influence coefficient matrix, according to a preferred embodiment of the present invention.

### DETAILED DESCRIPTION OF THE INVENTION

As used and defined herein, the terms “computer”, “assembler”, “solver”, and “generator” refers variously to software modifying a single computer, a plurality of computers with each computer in communication at least one of the plurality of computers, and multiple standalone computers.

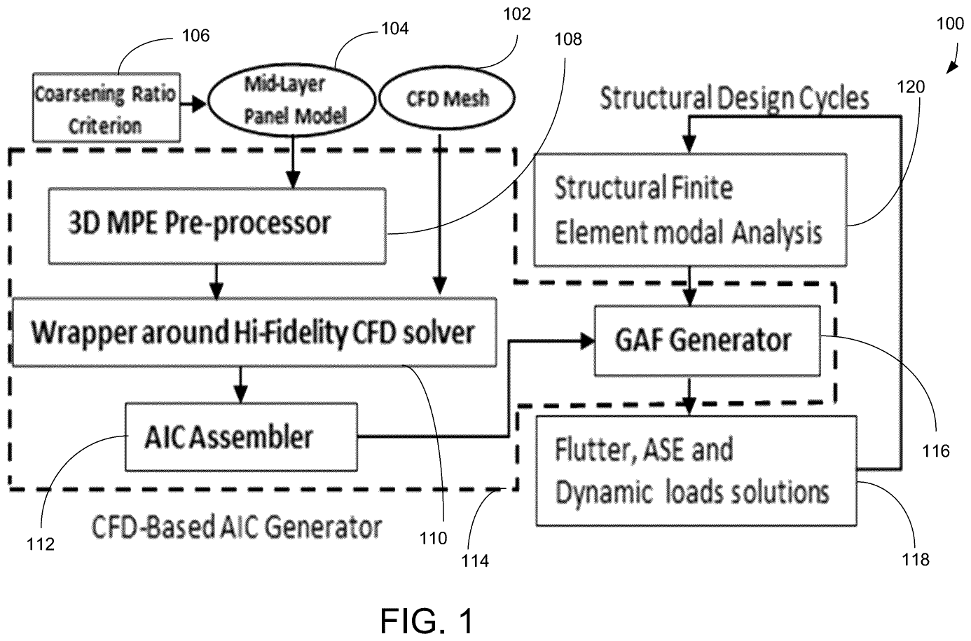

FIG. 1 illustrates components of the exemplary CFD-based AIC Generator 100 and its input and output for generating the GAFs during the flight vehicle's structural design cycles, in accordance with a preferred embodiment of the present invention. FIG. 1 shows the four components involved in the CFD-based AIC generator 100 and its input and output for flutter, ASE and dynamic loads analyses during the flight vehicle's structural design cycle. These four components are: (1) a three-dimensional (3D) Master Point Excitation (MPE) preprocessor 108, (2) a wrapper around a high fidelity CFD solver 110, (3) an AIC assembler 112, and (4) a GAF generator 116.

The input of the 3D MPE preprocessor 108 is a coarse panel model that is generated by coarsening the CFD surface mesh 616 and then connecting the coarser grid points 618, herein referred to as the panel grids, by panels, rendering a panel model. This can be achieved using commercial grid generation software such as Hypermesh developed by Altair or Pointwise developed by Pointwise Inc. In so doing, the panel grids are always the subset of the CFD surface grid points. This panel model serves as the mid-layer between the CFD solver and the structural finite element model. Therefore, it is called the Mid-Layer Panel Model (MLPM). The output 624 of the 3D MPE preprocessor 108 is the excitation amplitude matrix, denoted as Φ_{exc} ϵ [symbol] ^{(3N}^{_{CFD}}^{)×(3N}^{_{MLPM}}⁾, where N_{CFD} is the number of CFD surface grid points and N_{MLPM} is the number of panel grids.

To generate the excitation amplitude matrix, two steps are involved in the 3D MPE preprocessor 108. The first step is to identify the CFD surface grid points 606 that lie within each panel and the second step is to compute the excitation amplitude matrix 624 using the bi-linear Lagrange shape functions.

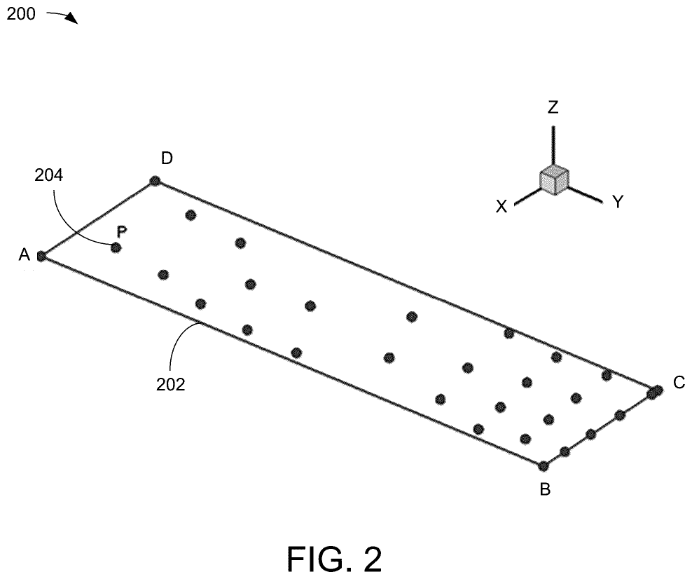

Identifying the CFD surface grid points that lie within each panel 202 is purely a geometric problem. The algorithm is illustrated as follows. Using the diagram shown in FIG. 2, for example, ABCD denote the four corner nodes of one MLPM panel 202, and Point P represents a CFD surface grid point 204. To check if a Point P is located inside of the Panel ABCD, it is required to check Point P against each edge, i.e., \vec{AB}, \vec{BC}, \vec{CD}, and \vec{DA}. The distance of Point P to the edge \vec{AB} can be computed as:

$${D}_{P 2 AB} = ( \frac{\vec{AB}}{\vert \vec{AB} \vert} \times \vec{AP} ) \cdot \vec{n} \qquad ( 11 )$$

where \vec{n} is the normal vector of the panel which points outwards from the body encompassed by the panel model. Similarly, the distance of Point P to the other three edges are computed as:

$${D}_{P 2 BC} = ( \frac{\vec{BC}}{\vert \vec{BC} \vert} \times \vec{BP} ) \cdot \vec{n} , \\ {D}_{P 2 CD} = ( \frac{\vec{CD}}{\vert \vec{CD} \vert} \times \vec{CP} ) \cdot \vec{n} , {D}_{P 2 DA} = ( \frac{\vec{DA}}{\vert \vec{DA} \vert} \times \vec{DP} ) \cdot \vec{n} \qquad ( 12 )$$

For Point P to be inside of Panel ABCD, the distances computed by Equation (11) and (12) must be greater than zero. To circumvent numerical truncation errors, a small tolerance value is introduced. If the absolute value of the distance, e.g., D_{P2AB}, is less than this small tolerance, Point P will be regarded as lying on the edge of the panel.

One more check is still needed to ensure Point P lies within the Panel ABCD; supposedly the CFD surface mesh and MLPM define the same surface. The distance of Point P to the flat plane of Panel ABCD is computed as:

$${D}_{P 2 Panel} = \vec{AP} \cdot \vec{n} \qquad ( 13 )$$

Similarly, if the absolute value of D_{P2AB} is less than the tolerance, Point P will be treated as it lies within the plane defined by Panel ABCD.

For each panel 202 of MLPM, the coordinates of the four corner points and its associating CFD surface grid points are first projected onto the panel plane. Afterwards, the bi-linear Lagrange shape functions are used to correlate the displacement field of each panel to that of the panel corner nodes:

$$u = {\sum }_{i = 1}^{4} {N}_{i} ( ϛ , η ) {u}_{i} \qquad ( 14 )$$

where uᵢ (i=1, . . . , 4) represents the displacements at the four corner points, and (ξ, η) are the local coordinates of each CFD surface grid point.

Using the iso-parametric element concept, the local coordinates of the CFD grids can be found from the following relation:

$$x = {\sum }_{i = 1}^{4} {N}_{i} ( ϛ , η ) {x}_{i} , y = {\sum }_{i = 1}^{4} {N}_{i} ( ϛ , η ) {y}_{i} \qquad ( 15 )$$

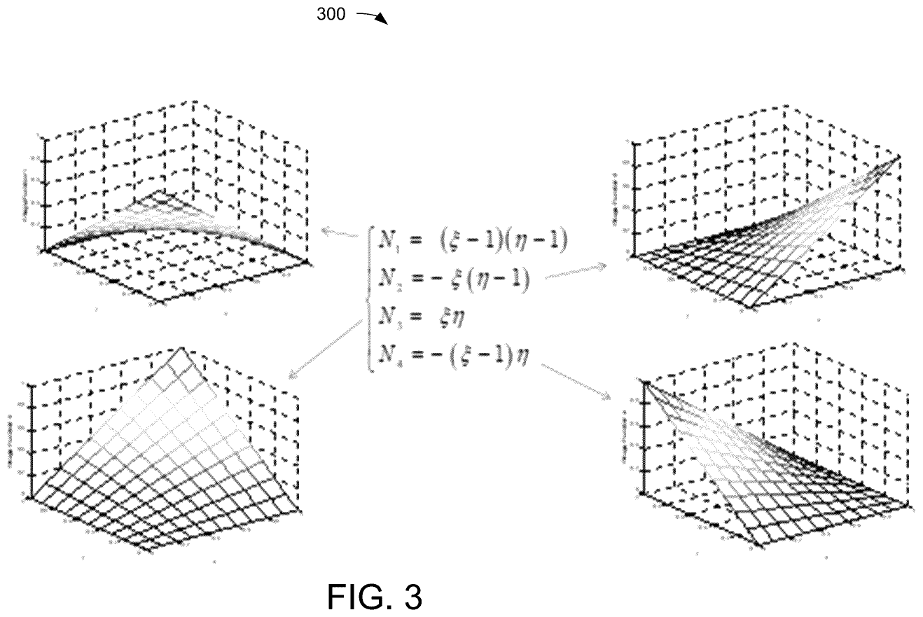

The bi-linear Lagrange shape functions Nₜ (ξ, η) used in the above equations are defined in a local coordinate system: (ξ: [0,1]; η: [0,1]), and are shown in FIG. 3.

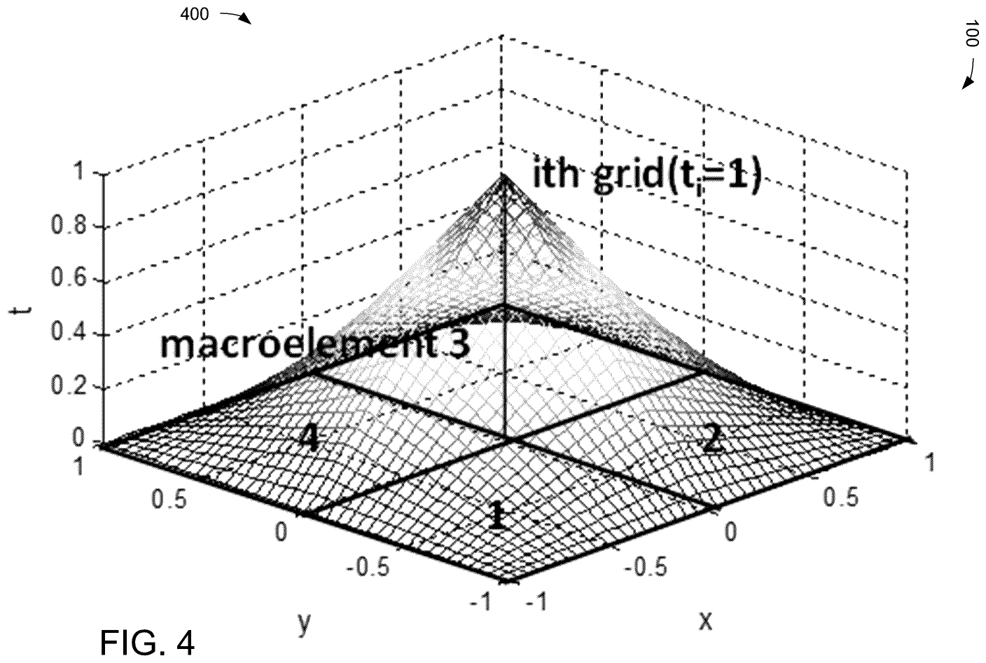

For the i^{th} panel grid, called the master grid, that is the common corner point shared by its adjacent panels (macroelements), by assigning the excitation amplitude at this panel grid to be unit (tᵢ=1) the excitation amplitudes at those CFD surface grids that lie within the adjacent macroelements, called the slave grids, can be computed by the bi-linear Lagrange shape functions and are depicted in FIG. 4. This leads to the vector {ϕ} shown in Equation (6) that contains all zeros except at rows corresponding to the CFD slave grids that lie within those panels surrounding the i^{th} master grid.

Considering that the displacement at each panel grid consists of three translational degrees-of-freedom along the x, y and z directions, the final assembled excitation amplitude matrix, Φ_{exc} ϵ [symbol] ^{(3N}^{_{CFD}}^{)×(3N}^{_{MLPM}}⁾, would have the dimensions of (3N_{CFD})×(3N_{MLPM}), i.e., the matrix's number of rows is (3×N_{CFD}), where N_{CFD} is the number of CFD surface mesh grids; and the number of columns is (3×N_{MLPM}), where N_{MLPM} is the number of MLPM nodes (the master grids). Each column of the excitation amplitude matrix then represents the motion of the CFD surface mesh due to one MLPM node's unit motion in one of the three translational directions. Obviously, the matrix, Φ_{exc}, is a highly sparse matrix.

Two set of inputs are needed by the wrapper around a high fidelity CFD solver. The first set is the CFD surface mesh and volume mesh, and the second set is the excitation amplitude matrix generated by the 3D MPE preprocessor 108. By treating each column of the excitation amplitude matrix as the unsteady motion on the CFD surface mesh, the wrapper applies either the ELVUS or FD technique to drive the high fidelity CFD solver to generate one column of the frequency-domain AIC matrix. Repeating the process (3×N_{MLPM}) times and collecting the frequency-domain unsteady pressure coefficients at CFD surface grid points yield the [AIC(ikⱼ)]ϵ [symbol] ^{N}^{_{CFD}}^{×3N}^{_{MLPM}} matrix at a given reduced frequency, (kⱼ). Thus, compared to the PPE approach, the MPE approach can reduce the number of CFD jobs for generating the AIC matrix from (3×N_{CFD}) to (3×N_{MLPM}).

A frequency-domain aeroelastic analysis usually requires the AIC matrices at Nₖ number of reduced frequencies, i.e. kⱼ, j=1, 2, . . . , Nₖ, where Nₖ is typically less than ten. Therefore, this process must be repeated for (3×N_{MLPM}×Nₖ) times, requiring the execution of (3×N_{MLPM}×Nₖ) CFD jobs to generate Nₖ number of AIC matrices in the frequency domain of interest. Using the index of the column number and the index of the reduced frequency, the wrapper can assemble a file name to save the frequency-domain Cₚ. Therefore, for (3×N_{MLPM}×Nₖ) CFD jobs the wrapper generates (3×N_{MLPM}×Nₖ) files with different file names and each file contains one column of the AIC matrix at a reduced frequency.

To further reduce the number of CFD jobs, a composite sinusoidal excitation technique is incorporated in the wrapper around the high fidelity CFD solver 110 which can generate Nₖ number of AIC matrices simultaneously.

The composite sinusoidal excitation reads:

$$ϛ ( t ) = {\sum }_{i = 1}^{{N}_{k}} {e}^{- {ak}_{i} T} sin ( {k}_{i} T ) \qquad ( 16 )$$

where a is the user assigned damping ratio to ensure that the excitation is a rapidly decay function and T is the non-dimensional time.

Applying Fourier transform for the j^{th} reduced frequency (kⱼ), denoted as [symbol] ⱼ, to both the time-domain linearized unsteady pressure coefficients computed by the high fidelity CFD solver as well as the composite sinusoidal excitation, [symbol] (t), and using the following equation yields the frequency-domain AIC matrix at reduced frequency=kⱼ. Repeating the application of Fourier transform using Equation (17) for j=1, 2, . . . Nₖ leads to .Nₖ number of AIC matrices.

$$AIC ( {ik}_{j} ) = \frac{{𝔽}_{j} ( AIC ( t ) )}{{𝔽}_{j} ( ϛ ( t ) )} j = 1 , 2 , ... {N}_{k} \qquad ( 17 )$$

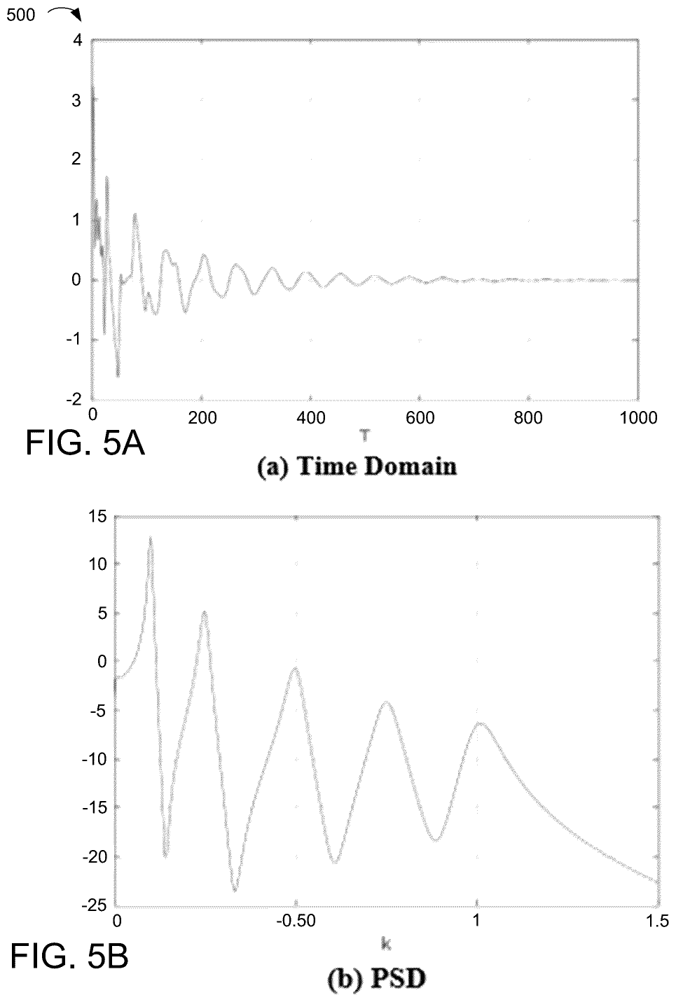

FIG. 5A presents a composite sinusoidal excitation for k=0.1, 0.25, 0.5, 0.75 and 1.0 and a=0.05. It is seen that this composite sinusoidal excitation decays to nearly zero at T=1000 with a=0.05; indicating that the maximum time of 1000 for the unsteady aerodynamic computation is sufficient to achieve a nearly zero aerodynamic response at T=1000. The Power Spectral Density (PSD) of the excitation presented in FIG. 5B shows that indeed five peaks occur at k=0.1, 0.25, 0.5, 0.75 and 1.0; implying that the concentrated energies at the five peaks can enhance the accuracy of AIC(ikⱼ), j=1, 2, . . . Nₖ at those reduced frequencies. Thus, the composite sinusoidal excitation technique can reduce the number of CFD jobs required for generating Nₖ number of AIC matrices from (3×N_{MLPM}×Nₖ) to (3×N_{MLPM}), a Nₖ number reduction of CFD jobs.

The major technical issue of the CFD-based AIC generation process is that the computational time to generate an AIC matrix is proportional to the number of panel grids (master points) of a MLPM. The number of surface grid points of a complex viscous CFD model can easily exceed millions. To generate an AIC matrix for such a CFD model with an affordable computational resource, the coarsening ratio (the ratio between the number of panel grids and CFD surface grid points) must be small but not too small to ensure the accuracy of the unsteady aerodynamic solutions. This technical issue can be resolved by the Coarsening Ratio Criterion (CRC) that can foresee the accuracy of the unsteady aerodynamic solutions prior to the generation of AIC matrices.

Theoretically, one can generate an AIC matrix using the Point-by-Point Excitation (PPE) technique, denoted as [AIC_{PPE}]. Then, the AIC matrix generated by the MPE technique, denoted as [AIC_{MPE}], in fact can be related to [AIC_{PPE}] via the excitation amplitude matrix, Φ_{exc} ϵ [symbol] ^{N}^{_{CFD}}^{×N}^{_{MLPM}}, based on the following equation:

[AIC_{MPE}]_{N}_{_{CFD}}_{×N}_{_{MLPM}}=[AIC_{PPE}]_{N}_{_{CFD}}_{×N}_{_{CFD}}[Φₑₓₑ]_{N}_{_{CFD}}_{×N}_{_{MLPM}} (18)

For a mode shape calculated or splined from the structural grids to the CFD surface grid points, denoted as {ϕ_{Spline}}_{N}_{_{CFD}}, its unsteady pressure coefficient (Cp) distribution can be computed from [AIC_{PPE}] by:

{Cp_{exact}}_{N}_{_{CFD}}=[AIC_{PPE}]_{N}_{_{CFD}}_{×N}_{_{CFD}}{ϕₛₚₗᵢₙₑ}_{N}_{_{CFD}} (19)

where {C_{exact}}_{N}_{_{CFD}} is called the exact Cp distribution since it is computed from [AIC_{PPE}] without approximation.

Because the panel grids are the subset of the CFD surface grid points, the mode shape at the panel grids, denoted as {ϕ_{MLPM}}_{N}_{_{MLPM}}, can be generated from {ϕ_{Spline}}_{N}_{_{CFD}}. Then, the unsteady Cp distribution, computed from {ϕ_{MLPM}}_{N}_{_{MLPM}} via [AIC_{MPE}], is an approximate solution, denoted as {Cpₐₚₚᵣₒₓᵢₘₐₜₑ}_{N}_{_{CFD}} that can be computed by the following equation:

{Cpₐₚₚᵣₒₓᵢₘₐₜₑ}_{N}_{_{CFD}}=[AIC_{MPE}]_{N}_{_{CFD}}_{×N}_{_{MLPM}}{ϕ_{MLPM}}_{N}_{_{MLPM}} (20)

To quantify the difference between {Cp_{exact}}_{N}_{_{CFD}} and {Cpₐₚₚᵣₒₓᵢₘₐₜₑ}_{N}_{_{CFD}}, one can use the Modal Assurance Criterion (MAC) of Cp (MAC_{Cp}) shown below:

$${MAC}_{Cp} = \frac{{( {C}_{{p}_{exact}}^{T} {C}_{{p}_{approximate}} )}^{2}}{( {C}_{{p}_{exact}}^{T} {C}_{{p}_{exact}} ) ( {C}_{{p}_{approximate}}^{T} {C}_{{p}_{approximate}} )} \qquad ( 21 )$$

Therefore, MAC_{Cp} can be used as an index to determine the accuracy of {Cpₐₚₚᵣₒₓᵢₘₐₜₑ}_{N}_{_{CFD}}. However, calculating MAC_{Cp} requires the generation of the AIC matrices. Since the goal of CRC is to establish a criterion that can foresee the accuracy of {Cpₐₚₚᵣₒₓᵢₘₐₜₑ}_{N}_{_{CFD}} before the AIC matrix is generated, a Modal Assurance Criterion of mode (MAC_{mode}) is derived by substituting Equation (18) into Equation (20) which yields:

{Cpₐₚₚᵣₒₓᵢₘₐₜₑ}_{N}_{_{CFD}}=[AIC_{PPE}]_{N}_{_{CFD}}_{×N}_{_{CFD}}{ϕ_{Transform}}_{N}_{_{CFD}} (22)

where

{ϕ_{Transform}}_{N}_{_{CFD}}=[Φ_{exc}]_{N}_{_{CFD}}_{×N}_{_{MaLPM}}{ϕ_{MLPM}}_{N}_{_{MLPM}} (23)

Comparing Equations (19) to (22), it is seen that MAC_{Cp} is equivalent to MAC_{mode} which is shown by the equation below:

$${MAC}_{mode} = \frac{{( {ϕ}_{Transform}^{T} {ϕ}_{Spline} )}^{2}}{( {ϕ}_{Transform}^{T} {ϕ}_{Transform} ) ( {ϕ}_{Spline}^{T} {ϕ}_{Spline} )} \qquad ( 24 )$$

Now, MAC_{mode} can be calculated before the AIC matrix is generated.

To amplify the difference between {ϕ_{Transform}} and {ϕ_{Spline}} calculated by MAC_{mode}, it is modified to define a Coarsening Ratio Criterion (CRC) shown below:

CRC=\sqrt{1−MAC_{mode}} (25)

Thus, the small CRC value implies that the AIC matrix can lead to an accurate unsteady Cp distribution. Numerical experience has shown that, in general, a MLPM that satisfies the CRC<3% requirement can guarantee the unsteady Cp solution to be accurate.

The AIC assembler assembles the frequency-domain AIC matrix, [AIC(ik)]ϵ [symbol] ^{N}^{_{CFD}}^{×N}^{_{MLPM}}, at a set of reduced frequencies by retrieving those (3×N_{MLPM}×Nₖ) files generated by the wrapper. These AIC matrices can be saved and subsequently be repeatedly used by the GAF generator during the flight vehicle's structural design cycle. Note that if such AIC matrices are already generated, the AIC assembler can be skipped.

The GAF generator essentially computes the GAFs due to structural modes, control surface kinematic modes and gust excitation using Equations (2) and (3) and consequently constructs Equation (1) to perform flutter, ASE, and dynamic loads analysis during the flight vehicle's structural design cycle. It should be noticed that during such a design cycle, the AIC matrices can be repeatedly used because of its structurally independent characteristics.

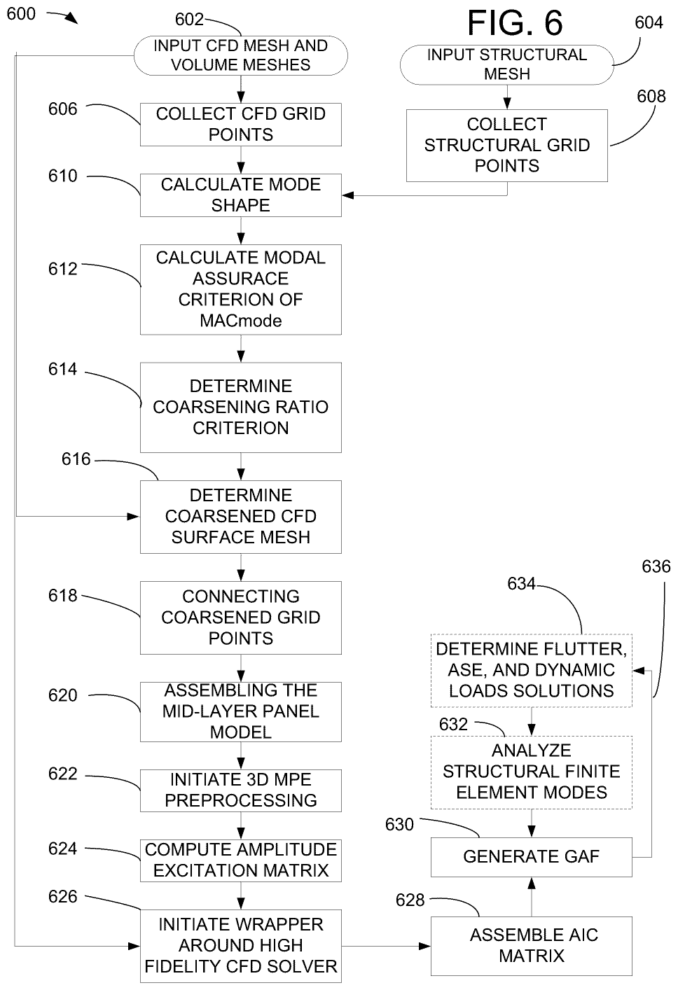

FIG. 6 is a process flow view of an exemplary method 600 of generation of CFD-based structurally independent aerodynamic influence coefficient matrix, according to a preferred embodiment of the present invention. The method begins with the input of CFD and volume meshes 602 and input of the corresponding structural mesh 604. The CFD surface mesh 102 includes panels 202 (see FIG. 2), panels grids, and panel grid points 204 which represent points on aerodynamic surfaces of an aircraft or other aerodynamic object. In step 606, CFD grid points are identified and collected. In step 608, structural grid points are identified and collected. In step 610, a mode shape vector is created via a calculation or spline from structural grid points to CFD grid points. In step 612, a modal assurance criterion (MAC_{mode}) is calculated. In step 614, a coarsening ratio criterion (CRC) is determined as a function of MAC_{mode}. CRC does not have to be recalculated 614 until the CFD mesh, the volume mesh, and/or the structural mesh change. In step 616 a coarsened CFD surface mesh is determined based on the CFD surface mesh 102 and a coarsening criterion. The coarsened grid points are connected in step 618 and assembled into a mid-layer panel model 104 (MLPM) in step 620. The MLPM is input to the master point excitation preprocessor 108 in step 622 leading to the computation of the amplitude excitation matrix in step 624. In step 626, the amplitude excitation matrix and the CFD mesh is supplied to the wrapper around high fidelity CFD solver 110. The wrapper preprocesses the inputs to be processed by the high fidelity CFD solver. In step 628, the AIC matrix is assembled from multiple AIC columns produced by the high fidelity CFD solver. I step 628, the Generalized Aerodynamic Forces are generated for use in determining flutter, aeroservoelastic, and dynamic loads solutions 634 for the aircraft under design and to analyze structural finite element modes in step 632. The design cycles 636 typically reuse the AIC matrices without recalculation.

The following claims have some functional language and do not contain any statements of intended use.

What is claimed is:

1. A method for generating and using an aerodynamic influence coefficient (AIC) matrix for use in aircraft design and simulation using software that modifies a computer for that purpose, comprising:
a. generating a coarsening ratio criterion without first calculating said AIC matrix;
b. generating said coarsening ratio from a computational fluid dynamics (CFD) surface mesh; and
c. producing said AIC matrix as a structurally independent AIC matrix;
d. reusing said AIC matrix over many said aircraft design cycles.

2. The method of claim 1, comprising computing said coarsening ratio criterion responsive to an input of a modal assurance criterion.

3. The method of claim 2, comprising computing said modal assurance criterion responsive to input of a mode shape.

4. The method of claim 3, comprising computing said mode shape responsive to an input of a plurality of CFD surface grid points.

5. The method of claim 4, comprising selecting said CFD surface grid points responsive to an input of a CFD mesh.

6. The method of claim 1, comprising:
a. assembling said AIC matrix responsive to an output of a high fidelity CFD solver; and
b. preprocessing, for input to said high fidelity CFD solver, an amplitude excitation matrix and a CFD mesh using a software wrapper around said high fidelity CFD solver.

7. The method of claim 6, comprising computing said amplitude excitation matrix responsive to input supplied by a three-dimensional master point excitation preprocessor.

8. The method of claim 7, comprising assembling a mid-layer panel model, responsive to input of connected coarsened grid points, for input to said three-dimensional master point excitation preprocessor.

9. The method of claim 8, comprising determining said connected coarsened grid points responsive to input of a coarsened CFD surface mesh.

10. The method of claim 9, comprising determining said coarsened CFD surface mesh responsive to an input of said coarsening ratio criterion and an input of said CFD surface mesh.

11. A method for generating a computational fluid dynamics (CFD)-based structurally independent aerodynamic influence coefficient (AIC) matrices in a computer modified by software to perform these steps, comprising the steps of:
a. receiving a CFD surface mesh and a CFD volume mesh comprising at least panels, panel grids, and panel grid points;
b. computing midlevel panel grids by connecting coarser grid points from said computational fluid dynamics surface mesh;
c. computing mode shapes of said panel grids from said midlevel panel grids to create a midlevel panel model (MLPM);
d. calculate a modal assurance criterion based on said midlevel panel model;
e. compute a coarsening ratio criterion from said modal assurance criterion;
f. compute an amplitude excitation matrix responsive to said modal assurance criterion using a 3D master point excitation (MPE) preprocessor;
g. provide said amplitude excitation matrix and said CFD meshes to a wrapper around a high-fidelity CFD solver;
h. assemble an aerodynamic influence coefficient (AIC) matrix responsive to output from said wrapper around said high-fidelity CFD solver; and
i. compute generalized aerodynamic forces (GAF) responsive to said AIC matrices.

12. The method of claim 11, comprising foreseeing the accuracy of an unsteady aerodynamic solution generated from a MLPM before said AIC matrices are computed.

13. The method of claim 11, comprising using bi-linear Lagrange shape functions to generate said excitation amplitude matrix

14. The method of claim 11, comprising:
a. treating each column of said excitation amplitude matrix of as an unsteady motion; and
b. driving said high fidelity CFD solver to compute the linearized unsteady pressure coefficient distribution as one column of said AIC matrix using a Finite Difference (FD) method or a numerically Exact Linearized Viscous/Inviscid Unsteady Solver (ELVUS) technique.

15. The method of claim 11, comprising generating AIC matrices at Nₖ number of reduced frequencies concurrently using a composite sinusoidal excitation technique.

16. The method of claim 11, comprising;
a. using an index of a column number and an index of a reduced frequency, said wrapper around a high fidelity CFD solver can assemble a file name to save a frequency-domain pressure coefficient distribution; and
b. using, for (3×N_{MLPM}×Nₖ) CFD jobs, where N_{MLPM} is a number of panel grids, said wrapper to generate (3×N_{MLPM}×Nₖ) files with different file names with each file containing one column of said AIC matrix at a reduced frequency.

17. The method of claim 16, comprising said AIC assembler assembling said frequency-domain AIC matrix, [AIC(ik)]ϵ [symbol] ^{N}^{_{CFD}}^{×N}^{_{MLPM}}, at a set of reduced frequencies by retrieving those (3×N_{MLPM}×Nₖ) files generated by said wrapper around said high fidelity CFD solver.

18. The method of claim 17, comprising a step of saving said AIC matrices for subsequent repeated use by said GAF generator to perform flutter, aeroservoelatic, and dynamic loads analysis during said flight vehicle's structural design cycle.

19. A method for generating a computational fluid dynamics (CFD)-based structurally independent aerodynamic influence coefficient (AIC) matrices in a computer modified by software to perform such steps, comprising the steps of:
a. receiving a CFD surface mesh and a CFD volume mesh comprising at least panels, panel grids, and panel grid points;
b. computing midlevel panel grids by connecting coarser grid points from said computational fluid dynamics surface mesh;
c. computing mode shapes of said panel grids from said midlevel panel grids to create a midlevel panel model (MLPM);
d. calculate a modal assurance criterion based on said midlevel panel model;
e. compute a coarsening ratio criterion from said modal assurance criterion;
f. compute an amplitude excitation matrix responsive to said modal assurance criterion using a 3D master point excitation (MPE) preprocessor;
g. provide said amplitude excitation matrix and said CFD meshes to a wrapper around a high-fidelity CFD solver;
h. assemble an aerodynamic influence coefficient (AIC) matrix responsive to output from said wrapper around said high-fidelity CFD solver;
i. compute generalized aerodynamic forces (GAF) responsive to said AIC matrices;
j. foreseeing an accuracy of an unsteady aerodynamic solution generated from a MLPM before said AIC matrices are computed.
k. using bi-linear Lagrange shape functions to generate said excitation amplitude matrix
l. treating each column of said excitation amplitude matrix of as an unsteady motion; and
m. driving said high fidelity CFD solver to compute a linearized unsteady pressure coefficient distribution as one column of said AIC matrix using a Finite Difference (FD) method or a numerically Exact Linearized Viscous/Inviscid Unsteady Solver (ELVUS) technique;
n. generating AIC matrices at Nₖ number of reduced frequencies concurrently using a composite sinusoidal excitation technique.

20. The method of claim 19, comprising:
a. using an index of a column number and an index of a reduced frequency, said wrapper around a high fidelity CFD solver can assemble a file name to save a frequency-domain pressure coefficient distribution; and
b. using, for (3×N_{MLPM}×Nₖ) CFD jobs, where N_{MLPM} is a number of panel grids, said wrapper to generate (3×N_{MLPM}×Nₖ) files with different file names with each file containing one column of said AIC matrix at a reduced frequency.
c. assembling, using said AIC assembler, a frequency-domain AIC matrix, [AIC(ik)]ϵ [symbol] ^{N}^{_{CFD}}^{×N}^{_{MLPM}}, at a set of reduced frequencies by retrieving those (3×N_{MLPM}×Nₖ) files generated by said wrapper around said high fidelity CFD solver.
d. saving said AIC matrices for subsequent repeated use by said GAF generator to perform flutter, aeroservoelatic, and dynamic loads analysis during said flight vehicle's structural design cycle.
